(19) United States
(12) Patent Application Publication
(10) Pub. No.: US 2024/0029498 A1
(43) Pub. Date: Jan. 25, 2024

(54) EXCHANGE DEVICE, EXCHANGE SYSTEM, AND MOBILE BATTERY

(71) Applicant: HONDA MOTOR CO., LTD., Tokyo (JP)

(72) Inventor: Yusuke Nakajima, Minato-ku, Tokyo (JP)

(21) Appl. No.: 18/043,364

(22) PCT Filed: Sep. 1, 2020
(86) PCT No.: PCT/JP2020/033093

§ 371 Date: Feb. 28, 2023

(51) Int. Cl. G07F 17/00; G07F 11/62; G07F 9/02

(52) U.S. Cl. CPC G07F 17/0042; G07F 11/62; G07F 9/023

(57) ABSTRACT

An exchange device capable of renting a mobile battery that can increase user satisfaction. The exchange device, which accommodates a plurality of mobile batteries and lends the accommodated mobile batteries when the mobile batteries are returned, includes: a return processing unit that acquires a usage state of the returned mobile batteries; and a lending processing unit that determines whether or not the mobile battery that can be lent is present for the plurality of mobile batteries accommodated in the exchange device on the basis of the usage state.

### TECHNICAL FIELD

The present invention relates to an exchange device that houses a plurality of mobile batteries and rents out a mobile battery housed therein when a mobile battery is returned, an exchange system that includes mobile batteries and the exchange device, and a mobile battery that is charged by the exchange device and rented out to a user.

### BACKGROUND ART

JP 2017-120475 A discloses an automated exchange device that, when a depleted mobile battery is set therein, dispenses a charged mobile battery.

### SUMMARY OF THE INVENTION

Even if the charged mobile battery dispensed from the automated exchange device is fully charged, the capability of the mobile battery differs according to a degree of deterioration, and therefore there is a concern that the user cannot be sufficiently satisfied depending on the capability of the dispensed charged mobile battery.

The present invention has been devised in order to solve this type of problem, and has the object of providing an exchange device and an exchange system that can rent out a mobile battery capable of increasing user satisfaction, as well as providing a mobile battery that can increase user satisfaction.

A first aspect of the present invention is an exchange device that is configured to house a plurality of mobile batteries and that, when one of the mobile batteries is returned, rents out another one of the mobile batteries housed therein, the exchange device comprising: a return processing section configured to acquire a usage state of the returned mobile battery; and a rental processing section configured to determine, based on the usage state, whether the mobile battery available to be rented out exists among the plurality of mobile batteries housed in the exchange device.

A second aspect of the present invention is an exchange device that is configured to house a plurality of mobile batteries and that, when one of the mobile batteries is returned, rents out another one of the mobile batteries housed therein, the exchange device comprising: a return processing section configured to acquire a deterioration degree of the returned mobile battery at a time of rental; and a rental processing section configured to determine, based on the deterioration degree, whether the mobile battery available to be rented out exists among the plurality of mobile batteries housed in the exchange device.

A third aspect of the present invention is an exchange system comprising: a plurality of mobile batteries; and an exchange device that is configured to house the plurality of mobile batteries and is configured to, when one of the mobile batteries is returned, rent out another one of the mobile batteries housed therein, wherein the exchange device includes: a return processing section configured to acquire a usage state of the returned mobile battery; and a rental processing section configured to determine, based on the usage state, whether the mobile battery available to be rented out exists among the plurality of mobile batteries housed in the exchange device.

A fourth aspect of the present invention is an exchange system comprising a plurality of mobile batteries; and an exchange device that is configured to house the plurality of mobile batteries and is configured to, when one of the mobile batteries is returned, rent out another one of the mobile batteries housed therein. Each of the mobile batteries includes a storage section configured to store a deterioration degree of the mobile battery at a time of rental. The exchange device comprises: a return processing section configured to acquire the deterioration degree of the returned mobile battery at the time of rental; and a rental processing section configured to determine, based on the deterioration degree, whether the mobile battery available to be rented out exists among the plurality of mobile batteries housed in the exchange device.

A fifth aspect of the present invention is a mobile battery that is charged by an exchange device and rented out to a user, the mobile battery comprising a storage section configured to store information indicating a deterioration degree of the mobile battery at a time of rental.

With the present invention, it is possible to increase the satisfaction of a user.

### BRIEF DESCRIPTION OF DRAWINGS

FIG. 1 shows the outline of a mobile battery rental service;

FIG. 2 is a chart showing an example of the correspondence among a classification of a mobile battery, a deterioration degree range of the mobile battery, and a service usage fee;

FIG. 3 is a schematic view of an exchange device;

FIG. 4 is a bock diagram of an exchange system;

FIG. 5 shows the mobile battery;

FIG. 6 is a flow chart showing the flow of a rental and return process performed by the exchange device;

FIG. 7 is a flow chart showing the flow of the rental and return process performed by the exchange device;

FIG. 8 is a flow chart showing the flow of the rental and return process performed by the exchange device;

FIG. 9 is a flow chart showing the flow of the rental and return process performed by the exchange device;

FIG. 10A shows a specific example used to describe the flow of the rental and return process;

FIG. 10B shows a specific example used to describe the flow of the rental and return process; and

FIG. 10C shows a specific example used to describe the flow of the rental and return process.

### DETAILED DESCRIPTION OF THE INVENTION

### First Embodiment

### [Outline of Mobile Battery Rental Service]

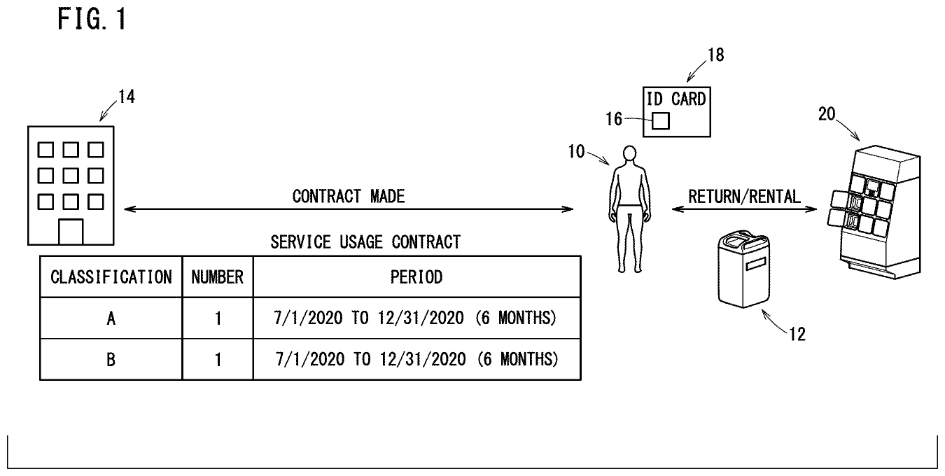

FIG. 1 shows the outline of a mobile battery rental service according to the present embodiment. In the present embodiment, a rental service for renting a mobile battery 12 to a user 10 and a charging service for a depleted mobile battery 12 are mainly provided as the mobile battery rental service. The mobile battery 12 is mounted in a riding lawn mower, a backpack blower, or another type of equipment, for example.

The user 10 who wants to use the mobile battery rental service enters into a service usage contract with a service provider 14. The service usage contract includes contract items relating to at least the classification of the mobile battery 12 to be rented out, the number of the mobile batteries 12 to be rented out, and the usage period of the mobile battery rental service. Upon entering into the service usage contract with the service provider 14, the user 10 is loaned an ID card 18 containing an IC chip 16 on which information concerning each contract item (referred to below as contract information) is written.

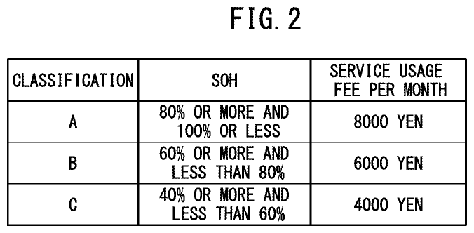

The degree of deterioration of the mobile battery 12 is divided into a plurality of prescribed ranges, and a classification for each mobile battery 12 is set according to each divided range concerning the degree of deterioration of the mobile battery 12. A monthly service usage fee is set according to the classification of the mobile battery 12. FIG. 2 is a chart showing an example of the correspondence among the classification of the mobile battery 12, the deterioration degree range of the mobile battery 12, and the service usage fee. In the present embodiment, a state of health (referred to below as SOH), which is one indicator of the deterioration degree of the mobile battery 12, is used as the deterioration degree. The SOH is represented by a percentage of the current amount of power that can be supplied when the mobile battery 12 is fully charged, with the amount of power that can be supplied when a new mobile battery 12 is fully charged being 100%. In other words, a higher SOH indicates a lower deterioration degree. Instead of the SOH, another indicator of the deterioration degree, such as the number of times the mobile battery 12 has been charged or the number of times the mobile battery 12 has been discharged may be used. The fewer times the mobile battery 12 has been charged, the lower the deterioration degree, and the fewer times the mobile battery 12 has been discharged, the lower the deterioration degree.

In the present embodiment, as shown in FIG. 2, Classification A is set for an SOH range greater than or equal to 80% and less than or equal to 100%, Classification B is set for an SOH range greater than or equal to 60% and less than 80%, and Classification C is set for an SOH range greater than or equal to 40% and less than 60%. In the present embodiment, as shown in FIG. 2, the monthly service usage fee for a mobile battery 12 with Classification A is set to be 8,000 Yen, the monthly service usage fee for a mobile battery 12 with Classification B is set to be 6,000 Yen, and the monthly service usage fee for a mobile battery 12 with Classification C is set to be 4,000 Yen.

An exchange device 20 receives the return of a mobile battery 12 from the user 10, charges the returned mobile battery 12, and rents out a charged mobile battery 12 to the user 10. The exchange device 20 is installed in a railway station, a convenience store, an electric product store, or the like in a city.

### [Configuration of Exchange Device]

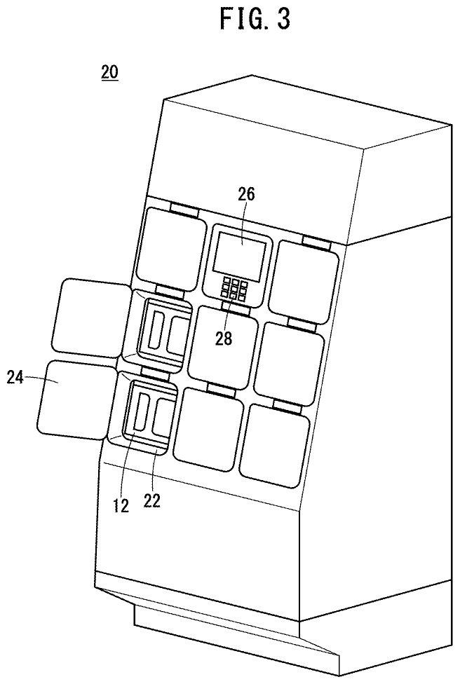

FIG. 3 is a schematic view of the exchange device 20. The exchange device 20 includes eight slots 22. A door 24 is provided to the open portion of each slot 22. Each slot 22 can house one mobile battery 12. The mobile battery 12 is charged while being housed in the slot 22.

By opening the door 24 of a slot 22 housing a mobile battery 12, the user 10 can pull the mobile battery 12 out from the slot 22 and perform a rental of the mobile battery 12. By opening the door 24 of a slot 22 that does not house a mobile battery 12, the user 10 can insert the mobile battery 12 into the slot 22 and perform a return of the mobile battery 12.

The exchange device 20 includes a display section 26 and an input section 28. The display section 26 displays information concerning the renting and returning of the mobile batteries 12, using characters, images, or the like. In the input section 28, information is input by the user 10 operating an input device such as a keyboard or numeric keypad. The input section 28 can acquire information from the IC chip 16 of the ID card 18 loaned to the user 10.

### [Configuration of Exchange System]

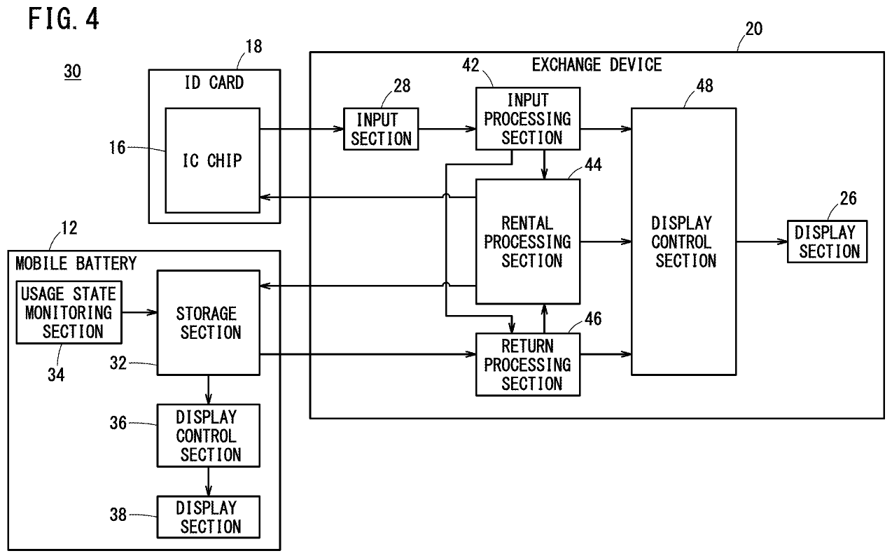

FIG. 4 is a block diagram of an exchange system 30. The exchange system 30 includes the mobile battery 12 and the exchange device 20.

The mobile battery 12 includes a storage section 32, a usage state monitoring section 34, a display control section 36, and a display section 38. The storage section 32 stores information relating to the mobile battery 12.

The usage state monitoring section 34 monitors the type of equipment in which the mobile battery 12 is mounted, and writes information concerning the type to the storage section 32. The usage state monitoring section 34 monitors the power usage amount of the equipment in which the mobile battery 12 is mounted, and writes information concerning the power usage amount to the storage section 32. The information concerning the type of equipment in which the mobile battery 12 is mounted and the information concerning the power usage amount of the equipment in which the mobile battery 12 is mounted, which have been written to the storage section 32, are stored in the storage section 32 in association with the deterioration degree information of the mobile battery 12.

The information relating to the mobile battery 12 is information concerning the deterioration degree of the mobile battery 12 at the time when the mobile battery 12 is rented out to the user 10 (referred to below as deterioration degree information), for example. The power usage amount is an average of the power discharge amount of the mobile battery 12 per instance, where one instance is from when the power source is switched from OFF to ON to when the power source is switched from ON to OFF in the equipment in which the mobile battery 12 is mounted, for example. Alternatively, the power usage amount may be the power discharge amount of the mobile battery 12 during a time period from when the mobile battery 12 is rented out to the user 10 from the exchange device 20 to when the mobile battery 12 is returned to the exchange device 20 by the user 10, for example.

The display control section 36 controls the display section 38. The deterioration degree (SOH) of the mobile battery 12, for example, is displayed on the display section 38. The classification of the mobile battery 12, for example, is displayed on the display section 38. The user 10 can select the equipment in which the mobile battery 12 can be mounted, based on the deterioration degree (SOH) or classification displayed on the display section 38.

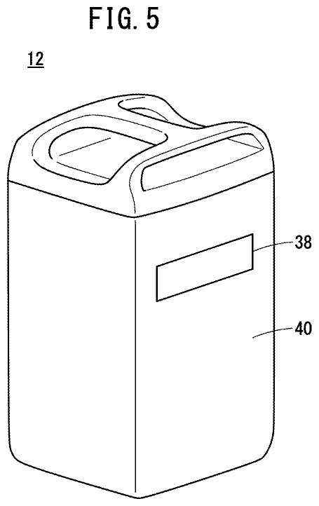

The mobile battery 12 includes a microcontroller (not shown in the drawings). The storage section 32 is a memory of the microcontroller, for example. The usage state monitoring section 34 and the display control section 36 are realized by a processor of the microcontroller executing a program stored in the memory of the microcontroller, for example. The storage section 32, the usage state monitoring section 34, and the display control section 36 are not limited to a microcontroller as long as they include a processor that executes a program and a non-transitory tangible computer-readable storage medium that can store various types of data in addition to the program. The display section 38 is a liquid crystal display, for example, and is controlled by the display control section 36 to display characters and the like. FIG. 5 shows the mobile battery 12. The display section 38 is embedded in a case 40 of the mobile battery 12.

The exchange device 20 includes an input processing section 42, a rental processing section 44, a return processing section 46, and a display control section 48, in addition to the slots 22, the display section 26, and the input section 28 described above.

The input processing section 42 processes the information input to the input section 28, and outputs this information to the rental processing section 44, the return processing section 46, and the display control section 48. The rental processing section 44 performs processing relating to the rental of the mobile battery 12 by the user 10. The return processing section 46 performs processing relating to the return of the mobile battery 12 by the user 10.

The exchange device 20 includes a computer that includes a storage and an arithmetic processing unit (not shown in the drawings). The arithmetic processing unit includes a processor, such as a central processing unit (CPU) or micro processing unit (MPU), and a memory made up of a non-transitory or transitory tangible computer-readable storage medium, such as a ROM or RAM. The storage is a non-transitory tangible computer-readable storage medium such as a hard disk or solid state drive (SSD). The input processing section 42, the rental processing section 44, the return processing section 46, and the display control section 48 are realized by the arithmetic processing unit executing the program stored in the storage.

### [Rental and Return Process]

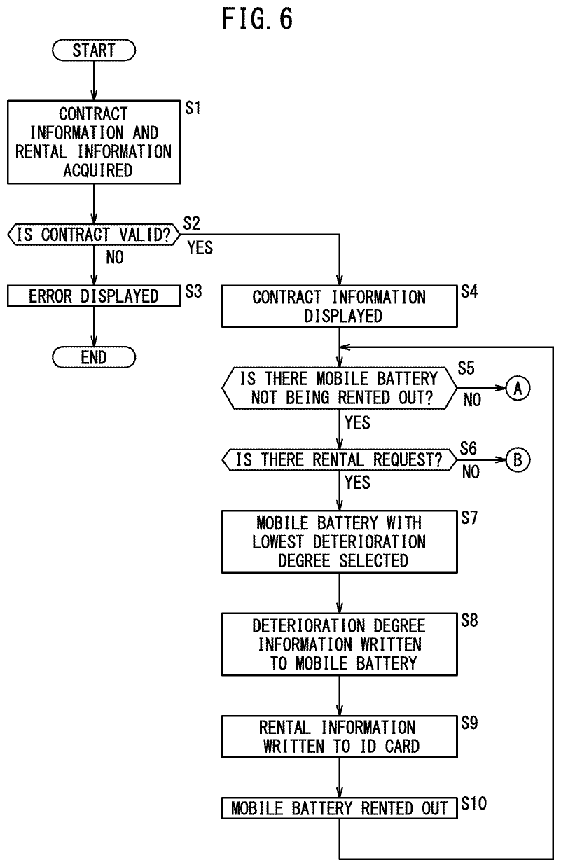

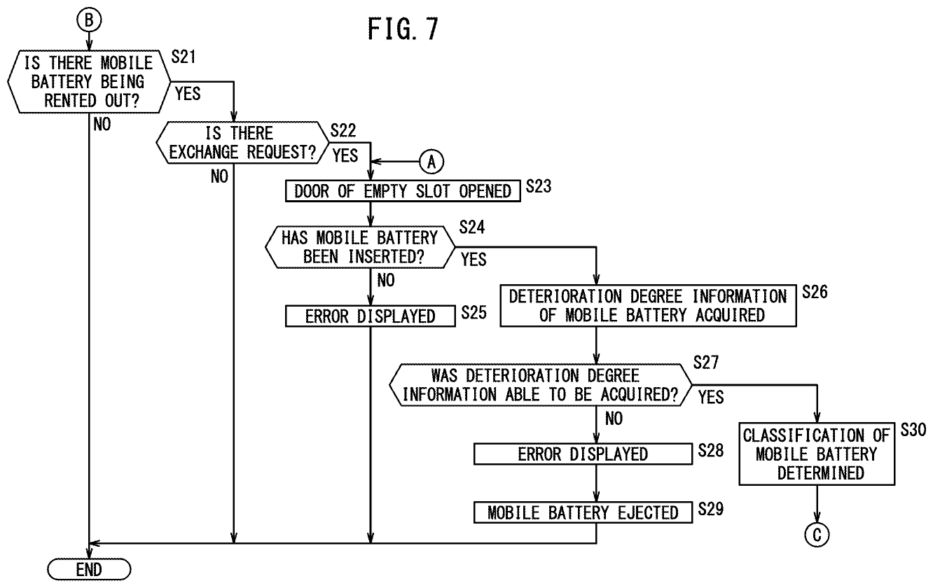

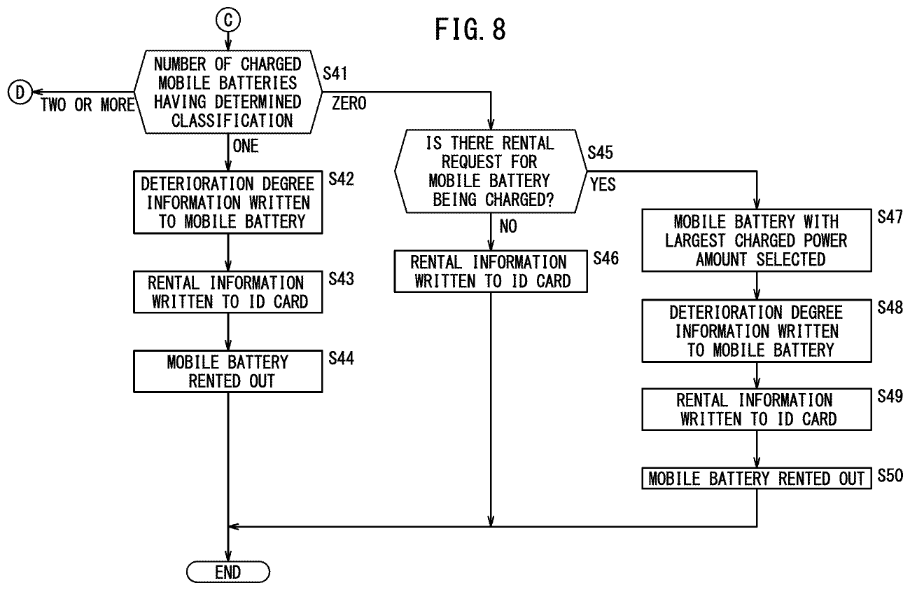

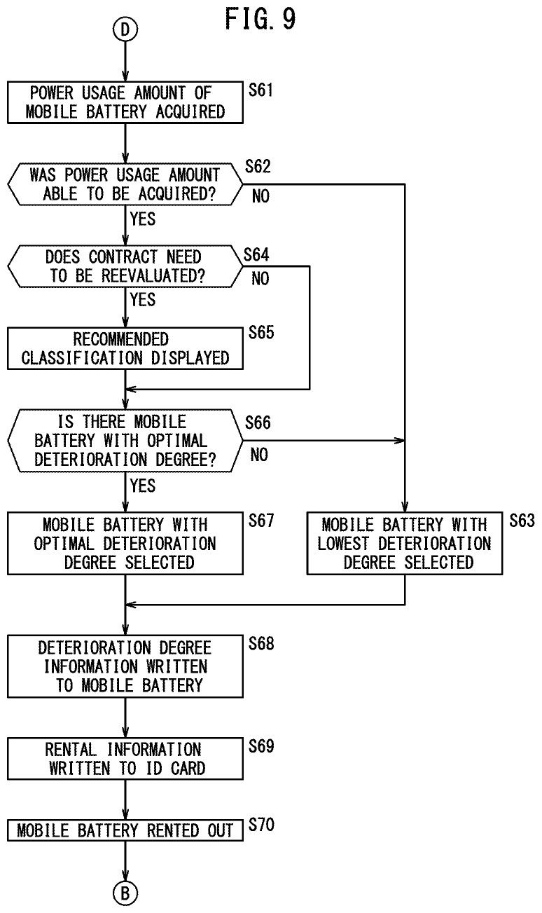

FIGS. 6 to 9 are flow charts showing the flow of the rental and return process performed by the exchange device 20. The rental and return process is performed every time the ID card 18 is held up to the input section 28 by the user 10.

In step S1, the input processing section 42 acquires the contract information and rental information from the IC chip 16 of the ID card 18 held up to the input section 28, and the process transitions to step S2. The rental information is information concerning the number of the mobile batteries 12 for each classification being rented out to the user 10 to whom this ID card 18 is loaned, and information concerning the usage period of the mobile battery rental service. Instead of acquiring the contract information and the rental information from the IC chip 16 of the ID card 18 held up to the input section 28, the input processing section 42 may acquire one or both of the contract information and the rental information that have been input by the user 10 operating the input section 28.

In step S2, the input processing section 42 determines whether the contract is valid, and the process transitions to step S3. The process transitions to step S4 if the contract is valid, and transitions to step S3 if the contract is invalid. The contract being invalid indicates that, for example, the date on which the rental and return process is being performed is before or after the usage period of the battery rental service. The contract may also be determined to be invalid if the contract information cannot be acquired in step S1.

In step S3, the input processing section 42 displays an error on the display section 26 via the display control section 48, and the rental and return process ends. The display of the error on the display section 26 is the display of a message, image, or the like indicating that it is currently before the usage period of the mobile battery rental service, that the usage period of the mobile battery rental service has ended, that the contract information cannot be acquired, or the like, for example.

In step S4, the input processing section 42 displays the contract information on the display section 26 via the display control section 48, and the process transitions to step S5.

In step S5, the input processing section 42 determines whether there is a mobile battery 12 that is not being rented out to the user 10. The process transitions to step S6 if there is a mobile battery 12 that is not being rented out to the user 10, and transitions to step S23 if there is no mobile battery 12 that is not being rented out to the user 10. A state in which there is a mobile battery 12 that is not being rented out to the user 10 indicates a state in which the number of the mobile batteries 12 being rented out to the user 10 is less than the number of the mobile batteries 12 set in the service usage contract. For example, if the number of the mobile batteries 12 set in the service usage contract with the user 10 is two, the input processing section 42 determines that there is a mobile battery 12 not being rented out to the user 10 if the number of the mobile batteries 12 being rented out to the user 10 is one.

In step S6, the input processing section 42 determines whether there is a rental request for a mobile battery 12 from the user 10. The process transitions to step S7 if there is a rental request, and transitions to step S21 if there is no rental request. The rental request for a mobile battery 12 from the user 10 is input by the user 10 operating the input section 28.

In step S7, the rental processing section 44 selects, from among the charged mobile batteries 12 housed in the exchange device 20, the mobile battery 12 with a classification corresponding to the mobile battery 12 not being rented out to the user 10 and with the lowest deterioration degree (highest SOH), and the process transitions to step S8.

In step S8, the rental processing section 44 writes, to the storage section 32 of the mobile battery 12 selected in step S7, the current deterioration degree information of the mobile battery 12, and the process transitions to step S9. Due to this, the deterioration degree information of the mobile battery 12 at the time this mobile battery 12 is rented out to the user 10 is stored in the storage section 32.

In step S9, the rental processing section 44 writes the rental information to the IC chip 16 of the ID card 18, and the process transitions to step S10. In step S9, the number of the mobile batteries 12 having the classification corresponding to the mobile battery 12 selected in step S7 is increased by one in the rental information.

In step S10, the rental processing section 44 opens the door 24 of the slot 22 in which the mobile battery 12 selected in step S7 is housed and rents out the mobile battery 12 to the user 10, and the process returns to step S5.

In step S21, the input processing section 42 determines whether there is a mobile battery 12 that is being rented out to the user 10. The process transitions to step S22 if there is a mobile battery 12 that is being rented out to the user 10, and the rental and return process ends if there is no mobile battery 12 being rented out to the user 10.

In step S22, the input processing section 42 determines whether there is an exchange request for a mobile battery 12 from the user 10. The process transitions to step S23 if there is an exchange request, and the rental and return process ends if there is no rental request. The exchange request for a mobile battery 12 from the user 10 is input by the user 10 operating the input section 28.

In step S23, the return processing section 46 opens the door 24 of an empty slot 22 of the exchange device 20, and the process transitions to step S24.

In step S24, the return processing section 46 determines whether a mobile battery 12 has been inserted into the slot 22. The process transitions to step S26 if a mobile battery 12 has been inserted into the slot 22, and transitions to step S25 if a mobile battery 12 has not been inserted into the slot 22. The determination about whether a mobile battery 12 has been inserted into the slot 22 is performed after a prescribed time has passed from when the door 24 of the slot 22 is opened.

In step S25, the return processing section 46 displays an error on the display section 26 via the display control section 48, and ends the rental and return process. The display of the error on the display section 26 is, for example, the display of a message, image, or the like indicating that the return process has been cancelled due to a mobile battery 12 not being inserted within a prescribed time.

In step S26, the return processing section 46 acquires the deterioration degree information from the storage section 32 of the mobile battery 12, and the process transitions to step S27. The deterioration degree information is the deterioration degree information that was written to the storage section 32 of the mobile battery 12 by the rental processing section 44 at the time when the returned mobile battery 12 was rented out.

In step S27, the return processing section 46 determines whether the deterioration degree information was able to be acquired. The process transitions to step S30 if the deterioration degree information was able to be acquired, and transitions to step S28 if the deterioration degree information was unable to be acquired.

The mobile batteries 12 rented out by the service provider 14 are sold in cities. Therefore, a mobile battery 12 purchased in a city or a mobile battery 12 rented from a different service provider might have the same shape as the mobile battery 12 rented out by the service provider 14. Accordingly, there are cases where a mobile battery 12 purchased in a city or a mobile battery 12 rented from a different service provider can be inserted into the slot 22.

When a mobile battery 12 is rented out, the format of the deterioration degree information written to the storage section 32 of the mobile battery 12 by the rental processing section 44 is a format unique to the service provider 14. Therefore, if the return processing section 46 is able to acquire the deterioration degree information, it can be determined that the mobile battery 12 inserted into the slot 22 is a mobile battery 12 that is being rented out by the service provider 14. On the other hand, if the return processing section 46 cannot acquire the deterioration degree information, it can be determined that the mobile battery 12 inserted into the slot 22 is not a mobile battery 12 that is being rented out by the service provider 14.

In step S28, the return processing section 46 displays an error on the display section 26 via the display control section 48, and the process transitions to step S29. The display of the error on the display section 26 is, for example, the display of a message, image, or the like indicating that the mobile battery 12 inserted into the slot 22 is not a mobile battery 12 that is being rented out by the service provider 14.

In step S29, the return processing section 46 opens the door 24 of the slot 22 into which the mobile battery 12 has been inserted, ejects the mobile battery 12, and ends the rental and return process.

In step S30, the return processing section 46 determines the classification of the mobile battery 12 based on the acquired deterioration degree information, and the process transitions to step S41. The classification can be determined to be Classification A if the acquired deterioration degree information indicates that the SOH is in a range greater than or equal to 80% and less than or equal to 100%, to be Classification B if the acquired deterioration degree information indicates that the SOH is in a range greater than or equal to 60% and less than 80%, and to be Classification C if the acquired deterioration degree information indicates that the SOH is in a range greater than or equal to 40% and less than 0.

In step S41, the rental processing section 44 determines the number of the mobile batteries 12 that correspond to the classification determined in step S30, among the charged mobile batteries 12 housed in the exchange device 20. The process transitions to step S42 if the number of the mobile batteries 12 corresponding to the classification determined in step S30 is one, transitions to step S45 if the number of the mobile batteries 12 corresponding to this classification is zero, and transitions to step S61 if the number of the mobile batteries 12 corresponding to this classification is two or more.

In step S42, the rental processing section 44 selects a mobile battery 12 that is charged, housed in the exchange device and corresponds to the classification determined in step S30. Then, the rental processing section 44 writes the current deterioration degree information of the selected mobile battery 12 to the storage section 32 of this mobile battery 12, and the process transitions to step S43.

In step S43, the rental processing section 44 writes the rental information to the IC chip 16 of the ID card 18, and the process transitions to step S44. In step S43, the number of the mobile batteries 12 having the classification determined in step S30 is increased by one in the rental information.

In step S44, the rental processing section 44 opens the door 24 of the slot 22 in which the mobile battery 12 selected in step S42 is stored, rents out the mobile battery 12 to the user 10, and ends the rental and return process.

In step S45, the input processing section 42 determines whether there is a rental request for a mobile battery 12 that is currently being charged. The process transitions to step S47 if there is a rental request, and transitions to step S46 if there is no rental request. The rental request from the user 10 for a mobile battery 12 currently being charged is input by the user 10 operating the input section 28.

In step S46, the rental processing section 44 writes the rental information to the IC chip 16 of the ID card 18, and ends the rental and return process. In step S46, the number of the mobile batteries 12 having the classification determined in step S30 is reduced by one in the rental information.

In step S47, the rental processing section 44 selects, from among the charged mobile batteries 12 housed in the exchange device 20, the mobile battery 12 that corresponds to the classification determined in step S30 and has the largest charged power amount (suppliable power amount), and the process transitions to step S48.

In step S48, the rental processing section 44 writes the current deterioration degree information of the mobile battery 12 selected in step S47 to the storage section 32 of this mobile battery 12, and the process transitions to step S49.

In step S49, the rental processing section 44 writes the rental information to the IC chip 16 of the ID card 18, and the process transitions to step S50. In step S49, the number of the mobile batteries 12 having the classification corresponding to the mobile battery 12 selected in step S47 is increased by one in the rental information.

In step S50, the rental processing section 44 opens the door 24 of the slot 22 in which the mobile battery 12 selected in step S47 is housed, rents out the mobile battery 12 to the user 10, and ends the rental and return process.

In step S61, the return processing section 46 acquires the information concerning the power usage amount from the storage section 32 of the mobile battery 12, and the process transitions to step S62.

In step S62, the return processing section 46 determines whether the information concerning the power usage amount was able to be acquired. The process transitions to step S64 if the information concerning the power usage amount was able to be acquired, and transitions to step S63 if the information concerning the power usage amount was unable to be acquired.

In step S63, the rental processing section 44 selects, from among the charged mobile batteries 12 housed in the exchange device 20, the mobile battery 12 that corresponds to the classification determined in step S30 and has the lowest deterioration degree (highest SOH), and the process transitions to step S68.

In step S64, the return processing section 46 determines whether the contract needs to be reevaluated. The process transitions to step S65 if the contract needs to be reevaluated, and transitions to step S66 if the contract does not need to be reevaluated.

The determination about whether the contract needs to be reevaluated is performed according to the amount of change in a state of charge (referred to below as SOC) obtained from the power usage amount of the returned mobile battery 12. The return processing section 46 determines that the contract needs to be reevaluated when the SOC change amount is small (for example, 20% or less), in a case where the returned mobile battery 12 has Classification A. The return processing section 46 determines that the contract needs to be reevaluated when the SOC change amount is small (for example, 20% or less) or large (for example, 80% or more), in a case where the returned mobile battery 12 has Classification B. The return processing section 46 determines that the contract needs to be reevaluated when the SOC change amount is large (for example, 80% or more), in a case where the returned mobile battery 12 has Classification C.

In step S65, the return processing section 46 displays the recommended classification on the display section 26 via the display control section 48, and the process transitions to step S66. The return processing section 46 selects Classification B as the recommended classification if the returned mobile battery 12 has Classification A and the SOC change amount is small (for example, 20% or less). The return processing section 46 selects Classification C as the recommended classification if the returned mobile battery 12 has Classification B and the SOC change amount is small (for example, 20% or less). The return processing section 46 selects Classification A as the recommended classification if the returned mobile battery 12 has Classification B and the SOC change amount is large (for example, 80% or more). The return processing section 46 selects Classification B as the recommended classification if the returned mobile battery 12 has Classification C and the SOC change amount is large (for example, 80% or more). The display section 26 displays a message, image, or the like indicating the recommendation of the selected classification.

In step S66, the rental processing section 44 determines whether there is a mobile battery 12 that corresponds to the classification determined in step S30 and has an optimal deterioration degree, among the charged mobile batteries 12 housed in the exchange device 20. The process transitions to step S67 if there is a mobile battery 12 that has the optimal deterioration degree, and transitions to step S63 if there is no mobile battery 12 that has the optimal deterioration degree.

The optimal deterioration degree is set according to the SOC change amount obtained from the power usage amount of the returned mobile battery 12. If the SOC change amount of the returned mobile battery 12 is large (for example, more than 60% and less than or equal to 100%), the deterioration degree of a mobile battery 12 that corresponds to the classification determined in step S30 and has the lowest deterioration degree (highest SOH), among the charged mobile batteries 12 housed in the exchange device 20, is set as the optimal deterioration degree. If the SOC change amount of the returned mobile battery 12 is small (for example, greater than or equal to 0% and less than or equal to 60%), the deterioration degree of a mobile battery 12 that corresponds to the classification determined in step S30 and has the second lowest deterioration degree (second highest SOH), among the charged mobile batteries 12 housed in the exchange device 20, is set as the optimal deterioration degree.

In step S67, the rental processing section 44 selects, from among the charged mobile batteries 12 housed in the exchange device 20, the mobile battery 12 that corresponds to the classification determined in step S30 and has the optimal deterioration degree set in step S66, and the process transitions to step S68.

In step S68, the rental processing section 44 writes the current deterioration degree information of the mobile battery 12 selected in step S63 or step S67 to the storage section 32 of this mobile battery 12, and the process transitions to step S69.

In step S69, the rental processing section 44 writes the rental information to the IC chip 16 of the ID card 18, and the process transitions to step S70. In step S69, the number of the mobile batteries 12 having the classification selected in step S63 or step S67 is increased by one in the rental information.

In step S70, the rental processing section 44 opens the door 24 of the slot 22 in which the mobile battery 12 selected in step S63 or step S67 is housed, and rents out the mobile battery 12 to the user 10, and the process returns to step S21.

### [Specific Example of Rental and Return Process]

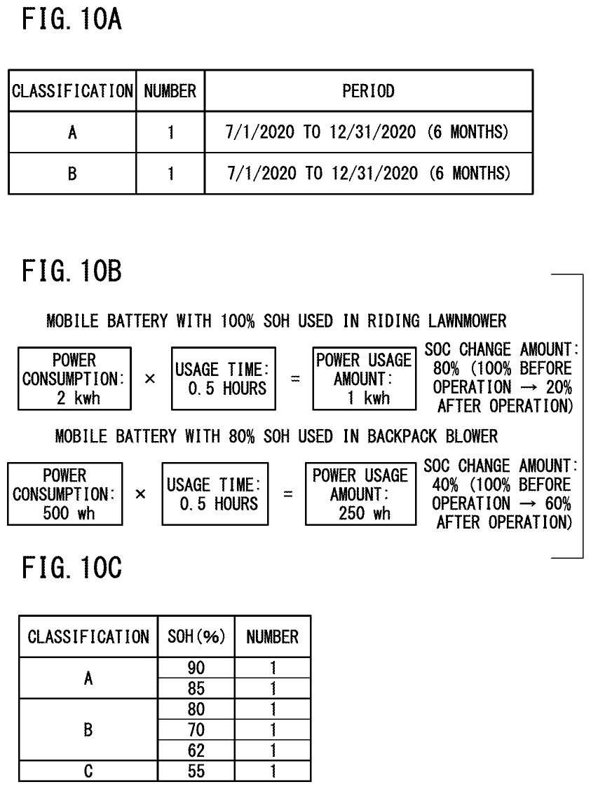

The flow of the rental and return process will be described using a specific example. FIGS. 10A to 10C show specific examples used to describe the flow of the rental and return process.

FIG. 10A shows contract information of a service usage contract with the service provider 14 entered into by the user who wants to use the mobile battery rental service. As shown in FIG. 10A, the user 10 enters into a service usage contract with the service provider 14 for six months of usage from Jul. 1, 2020 to Dec. 31, 2020 for each of one mobile battery 12 having Classification A and one mobile battery 12 having Classification B.

Here, it is assumed that one mobile battery 12 having Classification A and 100% SOH and one mobile battery 12 having Classification B and 80% SOH are already rented out to the user FIG. 10B shows a usage state of the mobile batteries 12 rented out to the user 10. As shown in FIG. 10B, the user 10 has used the mobile battery 12 having 100% SOH in a riding lawnmower. The power usage amount for that time was 1 kwh, and the SOC change amount was 80%. Furthermore, the user 10 has used the mobile battery 12 having 80% SOH in a backpack blower. The power usage amount for that time was 250 wh, and the SOC change amount was 40%.

FIG. 10C shows information about the charged mobile batteries 12 housed in the exchange device 20. One mobile battery 12 with Classification A at 90% and one mobile battery 12 with Classification A at 85% are housed in the exchange device 20. One mobile battery 12 with Classification B at 80%, one mobile battery 12 with Classification B at 70%, and one mobile battery 12 with Classification B at 62% are housed in the exchange device 20. One mobile battery 12 with Classification C at 55% is housed in the exchange device 20.

A case is assumed in which, in order to exchange the mobile battery 12 used in the riding lawnmower and the mobile battery 12 used in the backpack blower for the charged mobile batteries 12, the user 10 visits the location of the exchange device 20 on Aug. 3, 2020. When the user 10 holds the ID card 18 up to the input section 28, the rental and return process is performed by the exchange device 20.

When the rental and return process is performed, the process proceeds from step S1 to step S2. In step S2, the input processing section 42 determines whether the contract is valid. The date of Aug. 3, 2020 is within the usage period of the mobile battery rental service, so the contract is valid, and therefore the process proceeds from step S2 to step S4 to step S5.

In step S5, the input processing section 42 determines whether there is a mobile battery 12 that is not being rented out to the user 10. There are already two mobile batteries 12 being rented out to the user 10, and therefore the process proceeds from step S5 to step S23.

In step S23, it is assumed that the return processing section 46 opens the door 24 of an empty slot 22 of the exchange device 20 and the user 10 inserts, into this slot 22, a mobile battery 12 in which an SOH of 100% (deterioration degree at the time this mobile battery 12 was rented out) is written as the deterioration degree information.

After this, the process proceeds from step S23 to step S24 to step S26 to step S27 to step S30. In step S30, the return processing section 46 determines the classification of the mobile battery 12 based on the acquired deterioration degree information. Since the deterioration degree information of the inserted mobile battery 12 indicates an SOH of 100%, the classification of the inserted mobile battery 12 is determined to be Classification A.

The process proceeds from step S30 to step S41, and in step S41, the rental processing section 44 determines the number of the mobile batteries 12 that correspond to the classification determined in step S30, among the charged mobile batteries 12 housed in the exchange device 20. As shown in FIG. 10C, there are two charged mobile batteries 12 that correspond to Classification A, and therefore the process proceeds from step S41 to step S61 to step S62 to step S64.

In step S64, the return processing section 46 determines whether the contract needs to be reevaluated. The returned mobile battery 12 has Classification A and has an SOC change amount of 80%, and therefore it is determined that the contract does not need to be reevaluated and the process proceeds from step S64 to step S66.

In step S66, the rental processing section 44 determines whether there is a mobile battery 12 that corresponds to the classification determined in step S30 and has an optimal deterioration degree, among the charged mobile batteries 12 housed in the exchange device 20. The returned mobile battery 12 has Classification A and has an SOC change amount of 80%, and therefore the deterioration degree (SOH 90%) of the mobile battery 12 having the lowest deterioration degree (highest SOH) is set as the optimal deterioration degree.

Next, in step S67, the mobile battery 12 having the set SOH of 90% is selected. After this, the process proceeds from step S68 to step S69 to step S70, and in step S70, the selected mobile battery 12 having the SOH of 90% is rented out to the user 10.

The process proceeds from step S70 to step S21, and in step S21, the input processing section 42 determines whether there is a mobile battery 12 being rented out to the user 10. A mobile battery 12 is being rented out to the user 10, and therefore the process proceeds from step S21 to step S22.

In step S22, the input processing section 42 determines whether there is an exchange request for a mobile battery 12 from the user 10. When an exchange request for a mobile battery 12 has been input by the user 10, the process proceeds from step S22 to step S23.

In step S23, it is assumed that the return processing section 46 opens the door 24 of an empty slot 22 of the exchange device 20 and the user 10 inserts, into this slot 22, a mobile battery 12 in which an SOH of 80% is written as the deterioration degree information.

After this, the process proceeds from step S23 to step S24 to step S26 to step S27 to step S30, and in step S30, the return processing section 46 determines the classification of the mobile battery 12 based on the acquired deterioration degree information. Since the deterioration degree information of the inserted mobile battery 12 indicates an SOH of 80%, the classification of the inserted mobile battery 12 is determined to be Classification B.

The process proceeds from step S30 to step S41, and in step S41, the rental processing section 44 determines the number of the mobile batteries 12 that correspond to the classification determined in step S30, among the charged mobile batteries 12 housed in the exchange device 20. As shown in FIG. 10C, there are three charged mobile batteries 12 that correspond to Classification B, and therefore the process proceeds from step S41 to step S61 to step S62 to step S64.

In step S64, the return processing section 46 determines whether the contract needs to be reevaluated. The returned mobile battery 12 has Classification B and has an SOC change amount of 40%, and therefore it is determined the contract does not need to be reevaluated, and the process proceeds from step S64 to step S66.

In step S66, the rental processing section 44 determines whether there is a mobile battery 12 that corresponds to the classification determined in step S30 and has an optimal deterioration degree, among the charged mobile batteries 12 housed in the exchange device 20. The returned mobile battery 12 has Classification B and has an SOC change amount of 40%, and therefore the deterioration degree (SOH of 70%) of the mobile battery 12 having the second lowest deterioration degree (second highest SOH) is set as the optimal deterioration degree.

Next, in step S67, the mobile battery 12 having the set SOH of 70% is selected. After this, the process proceeds from step S68 to step S69 to step S70, and in step S70, the selected mobile battery 12 having the SOH of 70% is rented out to the user 10.

The process proceeds from step S70 to step S21, and in step S21, the input processing section 42 determines whether there is a mobile battery 12 being rented out to the user 10. There is a mobile battery 12 being rented out to the user 10, and therefore the process proceeds from step S21 to step S22.

In step S22, the input processing section 42 determines whether there is an exchange request for a mobile battery 12 from the user 10. When an exchange request for a mobile battery 12 is not input by the user 10, the rental and return process ends.

### [Effect]

Due to repeatedly being charged and discharged, the deterioration degree of the mobile battery 12 increases and the amount of power that can be supplied in the fully charged state (SOC of 100%) decreases. In other words, even mobile batteries 12 in the same fully charged state (SOC of 100%) will exhibit different capabilities according to the deterioration degree of each mobile battery 12. There is a concern that the user 10 cannot be sufficiently satisfied depending on the capability of the mobile battery 12 that has been rented out. Furthermore, there is a demand for the mobile battery 12 having a suitable amount of suppliable power to be rented out to the user 10, among the plurality of charged mobile batteries 12. The “capability” referred to here is the amount of power that can be supplied by the mobile battery 12.

Therefore, in the exchange device 20 of the present embodiment, the return processing section 46 acquires the power usage amount as the usage state of the mobile battery 12 returned by the user 10. The rental processing section 44 determines whether there is a mobile battery 12 that can be rented out among the plurality of mobile batteries 12 housed in the exchange device 20, based on the power usage amount.

Due to this, a determination can be made concerning whether there is a mobile battery 12 that has the capability needed by the user 10. Since the mobile battery 12 that has the capability needed by the user 10 is rented out to the user 10, the satisfaction of the user 10 can be improved.

Furthermore, the service provider 14 can prevent a mobile battery 12 that has a capability beyond the capability needed by the user 10 from being rented out to the user 10. Yet further, the service provider 14 can rent out a mobile battery 12 with a high capability to the user 10 who needs a mobile battery 12 with a high capability. Accordingly, the service provider 14 can improve the satisfaction of many users 10 who have rented the mobile batteries 12.

Furthermore, in the exchange device 20 of the present embodiment, the rental processing section 44 determines the mobile battery 12 to be rented out from among the plurality of mobile batteries 12 housed in the exchange device 20, based on the power usage amount.

Due to this, the mobile battery 12 having the capability needed by the user 10 can be rented out to the user 10, and it is possible to prevent a mobile battery 12 that has a lower capability than the capability needed by the user 10 from being rented out to the user 10. Therefore, a decrease in the satisfaction of the user 10 can be prevented.

Furthermore, the service provider 14 can prevent a mobile battery 12 that has a capability beyond the capability needed by the user 10 from being rented out to the user 10. Yet further, the service provider 14 can rent out a mobile battery 12 with a high capability to the user 10 who needs a mobile battery 12 with a high capability. Accordingly, the service provider 14 can improve the satisfaction of many users 10 renting the mobile batteries 12.

Further, in the exchange device 20 of the present embodiment, when the power usage amount is less than or equal to a threshold value, the rental processing section 44 determines a mobile battery 12 other than the mobile battery 12 with the lowest deterioration degree, among the plurality of mobile batteries 12 housed in the exchange device 20, to be the mobile battery 12 to be rented out.

Due to this, the service provider 14 can prevent a mobile battery 12 having an excessively high capability from being rented out to the user 10 for whom the power usage amount of the mobile battery 12 is low. Furthermore, the service provider 14 can rent out a mobile battery 12 with a high capability to the user 10 who needs a mobile battery 12 with a high capability. Accordingly, the service provider 14 can improve the satisfaction of many users 10 renting the mobile batteries 12.

Furthermore, in the exchange device 20 of the present embodiment, the return processing section 46 acquires the deterioration degree at the time when the mobile battery 12 returned by the user 10 was rented out. The rental processing section 44 determines whether there is a mobile battery 12 that can be rented out, among the plurality of mobile batteries 12 housed in the exchange device 20, based on the deterioration degree.

The deterioration degree of the mobile battery 12 at the time of return might be higher (deterioration might progress) than the deterioration degree of this mobile battery 12 at the time of rental. Since the determination about whether there is a mobile battery 12 that can be rented out is made based on the deterioration degree of the mobile battery 12 at the time of rental, the rental processing section 44 can determine whether there is a mobile battery 12 that has a capability equivalent to that of the mobile battery 12 rented previously. Accordingly, it is possible to restrict differences in capabilities among the mobile batteries 12 each time a mobile battery 12 is rented, and to improve the satisfaction of the user 10.

Furthermore, in the exchange device 20 of the present embodiment, based on the deterioration degree information stored in the storage section 32 of the returned mobile battery 12, the rental processing section 44 determines whether there is a mobile battery 12 that can be rented out among the plurality of mobile batteries 12 housed in the exchange device 20 and having the classification corresponding to the deterioration degree of the returned mobile battery 12 at the time of rental.

Due to this, it is possible to determine whether there is a mobile battery 12 that can be rented out, not based on the deterioration degree of the mobile battery 12 at the time of return, but based on the deterioration degree thereof at the time of rental. Accordingly, it is possible to determine whether there is a mobile battery 12 having a capability equivalent to that of the mobile battery 12 rented previously. Therefore, variation among the suppliable power amounts for each mobile battery 12 rented out to the user 10 can be restricted, the capability of the mobile battery 12 actually rented out can be assured to correspond to the classification of the mobile battery 12 to be rented out according to the contract made by the user 10, and the satisfaction felt by the user 10 can be increased.

Furthermore, in the exchange device 20 of the present embodiment, the return processing section 46 stops the return of a returned mobile battery 12 if the deterioration degree of the returned mobile battery 12 at the time of rental cannot be acquired.

Due to this, a mobile battery 12 purchased in a city or a mobile battery 12 rented from a different service provider can be restricted from being returned to the exchange device 20.

If a mobile battery 12 purchased in a city or a mobile battery 12 rented from a different service provider has been returned, the user 10 may be provided with a service different from the service provided in a case where a mobile battery 12 rented out by the service provider 14 has been returned. For example, in a case where a mobile battery 12 purchased in a city or a mobile battery 12 rented from a different service provider has been returned, the service for renting out another charged mobile battery 12 is not provided, but on a condition that an additional fee is paid, the user 10 may be provided with a service of charging the returned mobile battery 12. Due to this, the user 10 can be provided with a wide variety of services.

Furthermore, in the exchange device 20 of the present embodiment, the return processing section 46 determines whether the contract needs to be reevaluated, according to the power usage amount of the returned mobile battery 12. Then, if the contract needs to be reevaluated, the return processing section 46 displays the recommended classification on the display section 26 via the display control section 48.

The return processing section 46 may determine whether the contract needs to be reevaluated according to the deterioration degree information of the mobile battery 12 and the information concerning the type of equipment in which the mobile battery 12 is mounted, which are stored in the storage section 32 of the returned mobile battery 12. For example, in a case where the mobile battery 12 is mounted in equipment that consumes a large amount of power with respect to the classification of the mobile battery 12, it is determined that the contract needs to be reevaluated. When the contract needs to be reevaluated, the return processing section 46 displays the recommended classification on the display section 26 via the display control section 48. Due to this, the exchange device 20 can present the user 10 with the classification suitable for the equipment in which the mobile battery 12 is mounted.

Due to this, the user 10 can recognize the classification of the mobile battery 12 suitable for the power usage amount of the mobile battery 12 of the user 10.

Further, in the exchange device 20 of the present embodiment, if the number of the mobile batteries 12 being rented out to the user 10 is less than the number of the mobile batteries 12 set in the service usage contract, the rental processing section 44 rents out, to the user 10, the mobile battery 12 that has the classification of the service usage contract and has the lowest deterioration degree (highest SOH), from among the charged mobile batteries 12 housed in the exchange device 20.

Due to this, the mobile battery 12 having the classification of the service usage contract and having the greatest amount of power is rented out to the user 10, and therefore the satisfaction of the user 10 can be improved.

Furthermore, in the exchange device 20 of the present embodiment, when the power usage amount of the returned mobile battery 12 cannot be acquired, the rental processing section 44 rents out, to the user 10, the mobile battery 12 that corresponds to the classification of the returned mobile battery 12 and has the lowest deterioration degree (highest SOH), from among the charged mobile batteries 12 housed in the exchange device 20.

Due to this, the mobile battery 12 having the classification of the service usage contract and having the greatest amount of power is rented out to the user 10, and therefore the satisfaction of the user 10 can be improved.

The mobile battery 12 of the present embodiment includes the display section 38. The deterioration degree, the classification, and the like of the mobile battery 12 are displayed on the display section 38. Due to this, the user 10 can recognize the deterioration degree, the classification, and the like of the mobile battery 12 from the display of the display section 38.

[Technical Concepts Obtainable from Embodiment]

The technical concepts that can be grasped from the above-described embodiment will be described below.

Provided is the exchange device (20) that is configured to house a plurality of mobile batteries (12) and that, when one of the mobile batteries is returned, rents out another one of the mobile batteries housed therein, the exchange device comprising: the return processing section (46) that acquires the usage state of the returned mobile battery; and the rental processing section (44) that determines, based on the usage state, whether the mobile battery available to be rented out exists among the plurality of mobile batteries housed in the exchange device.

In the exchange device described above, the usage state may include the power usage amount used by the returned mobile battery; and the rental processing section may determine the mobile battery to be rented out, from among the plurality of mobile batteries housed in the exchange device, based on the power usage amount.

In the exchange device described above, when the power usage amount is less than or equal to the threshold value, the rental processing section may determine, from among the plurality of mobile batteries housed in the exchange device, the mobile battery other than the mobile battery with the lowest deterioration degree to be the mobile battery to be rented out.

Provided is the exchange device (20) that is configured to house a plurality of mobile batteries (12) and that, when one of the mobile batteries is returned, rents out another one of the mobile batteries housed therein, the exchange device comprising: the return processing section (46) that acquires the deterioration degree of the returned mobile battery at the time of rental; and the rental processing section (44) that determines, based on the deterioration degree, whether the mobile battery available to be rented out exists among the plurality of mobile batteries housed in the exchange device.

In the exchange device described above, the deterioration degree may be divided into the plurality of prescribed ranges, and the plurality of classifications may be set corresponding respectively to the divided ranges of the deterioration degree; and the rental processing section may determine whether the mobile battery available to be rented out exists among the plurality of mobile batteries housed in the exchange device and having the classification corresponding to the deterioration degree of the returned mobile battery at the time of rental.

In the exchange device described above, if the deterioration degree of the returned mobile battery at the time of rental fails to be acquired, the return processing section may stop the return of the returned mobile battery.

Provided is the exchange system (30) comprising: the plurality of mobile batteries (12); and the exchange device (20) that is configured to house the plurality of mobile batteries and that, when one of the mobile batteries is returned, rents out another one of the mobile batteries housed therein. The exchange device includes: the return processing section (46) that acquires the usage state of the returned mobile battery; and the rental processing section (44) that determines, based on the usage state, whether the mobile battery available to be rented out exists among the plurality of mobile batteries housed in the exchange device.

In the exchange system described above, the usage state may include the power usage amount used by the returned mobile battery; and the rental processing section may determine the mobile battery to be rented out, from among the plurality of mobile batteries housed in the exchange device, based on the power usage amount.

In the exchange device described above, when the power usage amount is less than or equal to the threshold value, the rental processing section may determine, from among the plurality of mobile batteries housed in the exchange device, the mobile battery other than the mobile battery with the lowest deterioration degree to be the mobile battery to be rented out.

Provided is the exchange system (30) comprising: the plurality of mobile batteries (12); and the exchange device (20) that is configured to house the plurality of mobile batteries and that, when one of the mobile batteries is returned, rents out another one of the mobile batteries housed therein. Each mobile battery includes the storage section (32) that stores the deterioration degree of the mobile battery at the time of rental. The exchange device includes: the return processing section (46) that acquires the deterioration degree of the returned mobile battery at the time of rental; and the rental processing section (44) that determines, based on the deterioration degree, whether the mobile battery available to be rented out exists among the plurality of mobile batteries housed in the exchange device.

In the exchange system described above, the deterioration degree may be divided into the plurality of prescribed ranges, and the plurality of classifications may be set corresponding respectively to the divided ranges of the deterioration degree; and the rental processing section may determine whether the mobile battery available to be rented out exists among the plurality of mobile batteries housed in the exchange device and having the classification corresponding to the deterioration degree of the returned mobile battery at the time of rental.

In the exchange system described above, if the deterioration degree of the returned mobile battery at the time of rental fails to be acquired, the return processing section may stop the return of the returned mobile battery.

Provided is the mobile battery (12) that is charged by the exchange device (20) and rented out to the user (10), the mobile battery comprising the storage section (32) that stores the information indicating the deterioration degree of the mobile battery at the time of rental.

In the mobile battery described above, the storage section may store the information concerning equipment in which the mobile battery is mounted, in association with the information indicating the deterioration degree of the mobile battery at the time of rental.

The mobile battery described above may include a display section (38) configured to display the deterioration degree of the mobile battery at the time of rental, or the classification of the mobile battery set according to the deterioration degree of the mobile battery at the time of rental.

### LIST OF REFERENCE NUMERALS

10: user
12: mobile battery
20: exchange device
30: exchange system
32: storage section
38: display section
44: rental processing section
46: return processing section

1. An exchange device that is configured to house a plurality of mobile batteries and that, when one of the mobile batteries is returned, rents out another one of the mobile batteries housed therein, the exchange device comprising:
a return processing section configured to acquire a usage state of the returned mobile battery; and
a rental processing section configured to determine, based on the usage state, whether the mobile battery available to be rented out exists among the plurality of mobile batteries housed in the exchange device.

2. The exchange device according to claim 1, wherein:
the usage state includes a power usage amount used by the returned mobile battery; and
the rental processing section determines the mobile battery to be rented out, from among the plurality of mobile batteries housed in the exchange device, based on the power usage amount.

3. The exchange device according to claim 2, wherein
when the power usage amount is less than or equal to a threshold value, the rental processing section determines, from among the plurality of mobile batteries housed in the exchange device, the mobile battery other than the mobile battery with a lowest deterioration degree to be the mobile battery to be rented out.

4. An exchange device that is configured to house a plurality of mobile batteries and that, when one of the mobile batteries is returned, rents out another one of the mobile batteries housed therein, the exchange device comprising:
a return processing section configured to acquire a deterioration degree of the returned mobile battery at a time of rental; and
a rental processing section configured to determine, based on the deterioration degree, whether the mobile battery available to be rented out exists among the plurality of mobile batteries housed in the exchange device.

5. The exchange device according to claim 4, wherein:
the deterioration degree is divided into a plurality of prescribed ranges, and a plurality of classifications are set corresponding respectively to the divided ranges of the deterioration degree; and
the rental processing section determines whether the mobile battery available to be rented out exists among the plurality of mobile batteries housed in the exchange device and having a classification corresponding to the deterioration degree of the returned mobile battery at the time of rental.

6. The exchange device according to claim 4, wherein
if the deterioration degree of the returned mobile battery at the time of rental fails to be acquired, the return processing section stops return of the returned mobile battery.

7. An exchange system comprising:
a plurality of mobile batteries; and
an exchange device that is configured to house the plurality of mobile batteries and is configured to, when one of the mobile batteries is returned, rent out another one of the mobile batteries housed therein,
wherein the exchange device includes:
a return processing section configured to acquire a usage state of the returned mobile battery; and
a rental processing section configured to determine, based on the usage state, whether the mobile battery available to be rented out exists among the plurality of mobile batteries housed in the exchange device.

8. The exchange system according to claim 7, wherein:
the usage state includes a power usage amount used by the returned mobile battery; and
the rental processing section determines the mobile battery to be rented out, from among the plurality of mobile batteries housed in the exchange device, based on the power usage amount.

9. The exchange system according to claim 8, wherein
when the power usage amount is less than or equal to a threshold value, the rental processing section determines, from among the plurality of mobile batteries housed in the exchange device, the mobile battery other than the mobile battery with a lowest deterioration degree to be the mobile battery to be rented out.

10. An exchange system comprising:
a plurality of mobile batteries; and
an exchange device that is configured to house the plurality of mobile batteries and is configured to, when one of the mobile batteries is returned, rent out another one of the mobile batteries housed therein, wherein:
each of the mobile batteries includes a storage section configured to store a deterioration degree of the mobile battery at a time of rental; and
the exchange device comprises:
a return processing section configured to acquire the deterioration degree of the returned mobile battery at the time of rental; and
a rental processing section configured to determine, based on the deterioration degree, whether the mobile battery available to be rented out exists among the plurality of mobile batteries housed in the exchange device.

11. The exchange system according to claim 10, wherein:
the deterioration degree is divided into a plurality of prescribed ranges, and a plurality of classifications are set corresponding respectively to the divided ranges of the deterioration degree; and
the rental processing section determines whether the mobile battery available to be rented out exists among the plurality of mobile batteries housed in the exchange device and having a classification corresponding to the deterioration degree of the returned mobile battery at the time of rental.

12. The exchange system according to claim 10, wherein
if the deterioration degree of the returned mobile battery at the time of rental fails to be acquired, the return processing section stops return processing of the returned mobile battery.

13. A mobile battery that is charged by an exchange device and rented out to a user, the mobile battery comprising:
a storage section configured to store information indicating a deterioration degree of the mobile battery at a time of rental.

14. The mobile battery according to claim 13, wherein
the storage section stores information concerning equipment in which the mobile battery is mounted, in association with the information indicating the deterioration degree of the mobile battery at the time of rental.

15. The mobile battery according to claim 13, further comprising:
a display section configured to display the deterioration degree of the mobile battery at the time of rental, or a classification of the mobile battery set according to the deterioration degree of the mobile battery at the time of rental.
